(19) United States
(12) Patent Application Publication
(10) Pub. No.: US 2009/0194911 A1
(43) Pub. Date: Aug. 6, 2009

(54) OPTICAL MICRO-ARRAY FOR E.G. MICRO SENSORS

(75) Inventors: Renatus Marius De Zwart, Eindhoven (NL); Joseph Mathias Gerardus Kunen, Schiedam (NL); Augustines Gerardus Maria Biemans, Geldrop (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nederlandse Organisatie voor toegepast- natuurwetenschappelijk Onderzoek TNO, Delft (NL)

(21) Appl. No.: 12/161,513

(22) PCT Filed: Jan. 18, 2007
(86) PCT No.: PCT/NL07/50021

§ 371 Date: Sep. 26, 2008

(30) Foreign Application Priority Data
Jan. 18, 2006 (EP) 06075107.0
Jun. 27, 2006 (EP) 06076307.5

(51) Int. Cl. B29C 35/08

(52) U.S. Cl. 264/402

(57) ABSTRACT

Method for manufacturing a polymer body (1) which comprises first areas (2) which are transparent and areas (3) which are non-transparent. A semi-manufactured body comprising said first areas and said second areas which are, however, either both transparent or both non-transparent, is produced by applying a well-known method. When the semi-manufactured body is entirely transparent, the polymer in the second areas is heated to above the polymer's melting temperature and subsequently cooled so slowly as to realize substantial crystallization of the polymer in the second areas. When the semi-manufactured body is entirely non-transparent, the polymer in said first areas is heated to above the polymer's melting temperature and subsequently cooled so quickly as to prevent substantial crystallization of the polymer in the first areas.

### FIELD

The invention concerns the manufacturing of an optical micro-array, comprising a high quality polymer (plastic) window array for e.g. micro sensors.

### BACKGROUND

Polymer optical micro-arrays for e.g. multi-analyte sensors in clinical microbiological analysis, environmental, health and safety, food/beverage and chemical processing applications must be highly transparent and the mutual crosstalk of the optical analysis signals minimal. Conventional polymer processing techniques trying to produce one-piece window arrays have not been successful until now as they did not result in a sufficiently high transparency of the windows (low optical signal attenuation) and/or a sufficiently low signal crosstalk level between those windows.

Use of two materials, viz. optical transparent micro structures for transferring optical signals and an optical non-transparent frame material for mechanical support and optical signal isolation (crosstalk prevention), gives problems w.r.t. the manufacturing and particularly the assembly of such arrays. Positioning and fixing of the optical micro structures (lenses, windows) within the frame make high demands on process and materials (location accuracy, damage of optical structures, shrinking differences) while extra care is required for mutual binding the micro structures and frame.

### SUMMARY

Aim of the present invention is to provide a method for manufacturing a polymer body which comprises one or more first areas which are transparent and one or more second areas which are non-transparent.

According to an aspect of the invention, there is provided an optical micro-array for use in conjunction with a chemical sensor, comprising a polymer body comprising one or more first areas which are transparent, the transparent areas sectioned by second areas which are non-transparent; wherein the micro-array is comprised of a single body; the transparent areas being formed by non-crystallized polymer and the non-transparent areas being formed by crystallized polymer.

The micro-array can be manufactured based on the understanding that the morphology of polymers may comprise amorphous (non-crystalline, transparent) areas and/or crystalline (non-transparent) areas. The degree of crystallinity of so-called semi-crystalline polymers is determined by the thermal history of the polymer, especially by the cooling rate. In general it can be stated that cooling down quickly will suppress the formation of crystals, resulting in a more amorphous polymer, whereas slow cooling will lead to the formation and grow of crystals.

According to another aspect, the method according to the invention comprises next steps:

a. a semi-manufactured body is produced by applying any method known as such, the semi-manufactured body comprising said first and second areas which, however, in this semi-manufactured stage are either both transparent or both non-transparent;
b. when the first and the second areas of the semi-manufactured body are transparent, the polymer in said second areas is heated to above the polymer's melting temperature and subsequently cooled so slowly as to realize substantial crystallization of the polymer in the second areas;
c. when the first and the second areas of the semi-manufactured body are non-transparent, the polymer in said first areas is heated to above the polymer's melting temperature and subsequently cooled so quickly as to prevent substantial crystallization of the polymer in the first areas
d. in a further additional step, the transparent areas may be provided with an optically active material; for optical read out before, and during or after exposure to a chemical substance to be tested; so that the polymer window can be used for testing purposes in a (micro) sensor. Preferably, the sensor is of a multi-analyte type.

It may be preferred to start with an entirely non-transparent semi-manufactured body (option c), because the cooling down time, which has to be so short as to prevent substantial crystallization of the polymer in the first areas, will be, in consequence, shorter than when starting with an entirely transparent semi-manufactured body (option b), where the cooling down time has to be rather long, viz. long enough for the crystallization process in the second areas to realize a non-transparent morphology there.

On the other side, it may preferred to start with an entirely transparent semi-manufactured body (option b), because the focus can primarily be put on the optical transparency of the starting material of the semi-manufactured body, ignoring possible signal crosstalk problems, which are resolved in the final manufacturing stage, viz. by (re)heating and crystallization the second areas, serving as crosstalk preventing barriers.

The semi-manufactured polymer body may be manufactured by e.g. a well-known process like injection moulding, warm pressing of sheet or film e.g. by means of embossing or via a roll-to-roll process etc. When starting with a entirely transparent semi-manufactured body, in the second production step optical non-transparent, anti-crosstalk barriers are realized e.g. around the optical transparent (micro)windows. When starting with a entirely non-transparent semi-manufactured body, in the second production step optical transparent e.g. (micro)windows may be made within the non-transparent environment. To either case, the polymer of the semi-manufactured body is melted locally and then cooled in a controlled way, either quickly, to prevent (re)crystallization, or slowly, to realize deliberate (re)crystallization.

Local heating of the semi-manufactured body can be performed within or outside the mould which was used to make the semi-manufactured body. Electric, fluid, laser heating, microwave and ultrasonic heating may be applied to change the amorphous polymer structure into a semi-crystalline or inversely. Without additives to the polymer, a CO₂ laser may be used or, by adding a NIR absorbing additive, a diode laser.

Cooling rates for a polymer to become mainly amorphous are in the order of tens of degrees Celsius per second. When, however, the cooling down rate is about hundredths of degrees Celsius per second, a substantial crystalline state will be reached.

### EXEMPLARY EMBODIMENTS

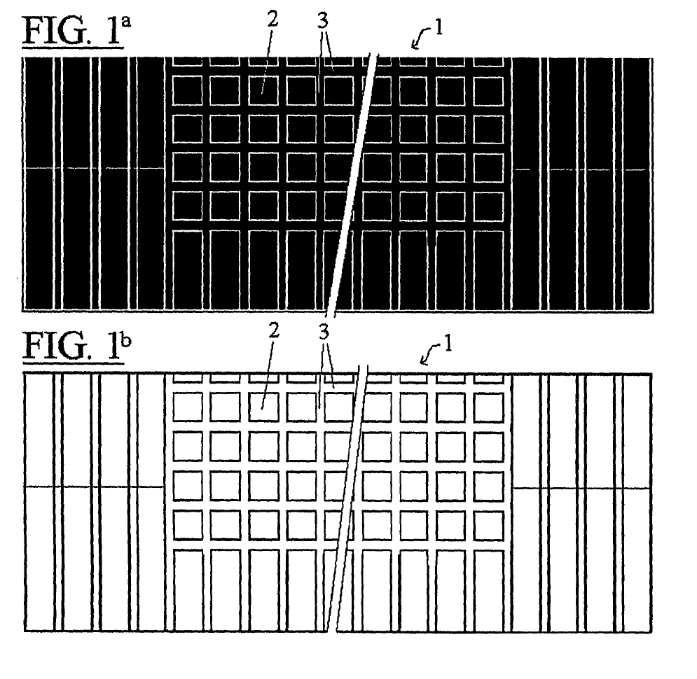

FIGS. 1a and 1b show two exemplary embodiments of a semi-manufactured body, serving as a starting structure for a micro-window array, to be made in a subsequent step.

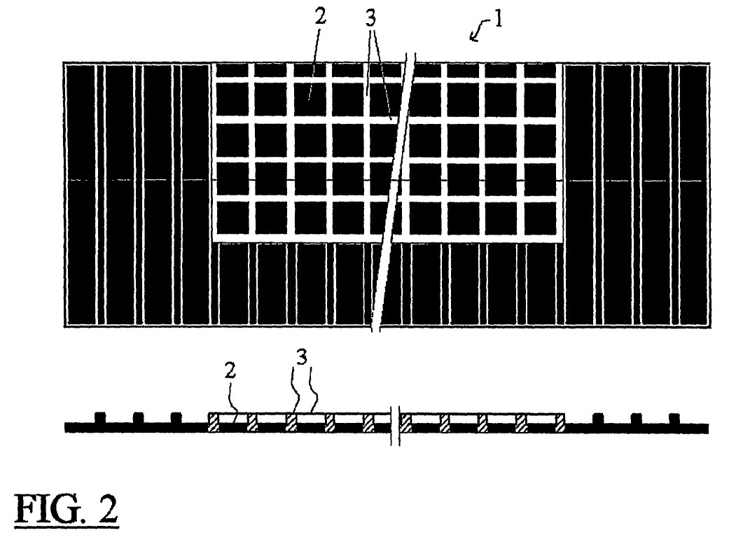

FIG. 2 shows an example of a polymer body made according to the method outlined above, starting from a fully transparent semi-manufactured body as shown in FIG. 1a.

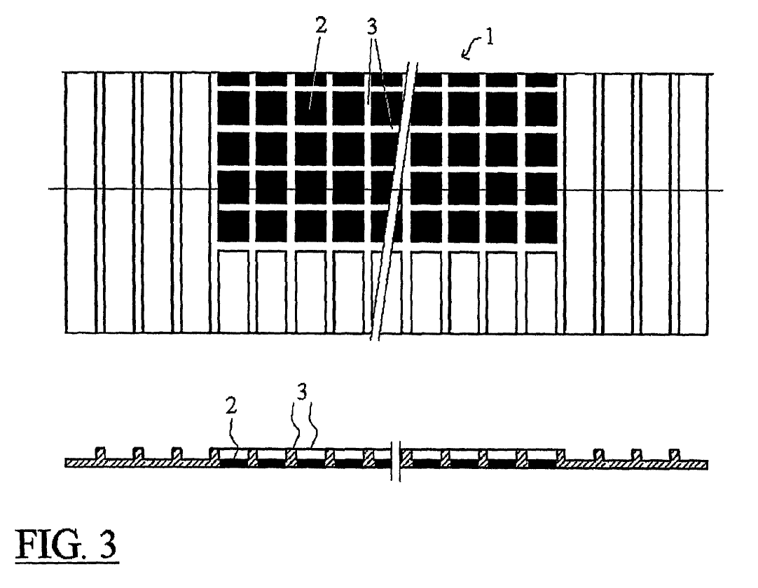

FIG. 3 shows an example of a polymer body made according to the method outlined above, starting from a fully non-transparent semi-manufactured body as shown in FIG. 1b.

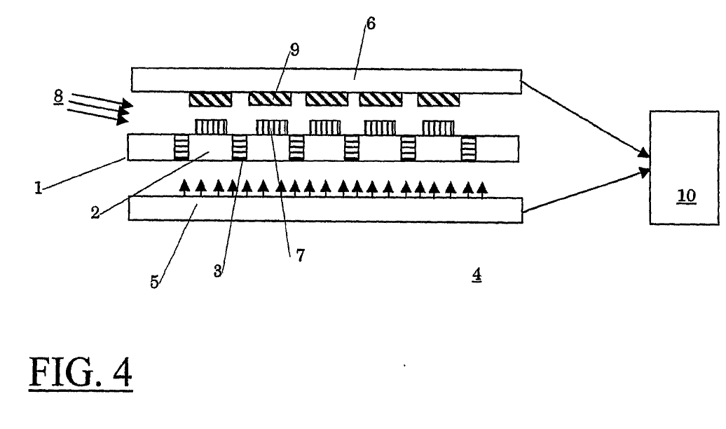

FIG. 4 schematically shows a chemical sensor comprising an optical micro-array according to an aspect of the invention.

FIG. 1a shows a entirely transparent (coloured black) polymer body 1 in semi-manufactured fashion, e.g. made by injection moulding, which comprises several first areas 2 and several second areas 3. Both, the first areas 2 and the second areas 3 are transparent, as is the entire body 1.

FIG. 1b shows a entirely non-transparent (coloured white) polymer body 1 in semi-manufactured fashion, e.g. made by injection moulding, which comprises several first areas 2 and several second areas 3. Both, the first areas 2 and the second areas 3 are non-transparent, as is the entire body 1.

Typical dimensions of the areas 2 are 2×2 mm, so that for instance an array area on body 1 of typically 30×30 mm is available of about 100 transparent areas 2. On these transparent areas 2, preferably, of the body 1 a chemically selective coating is applied, for instance, with dispensing techniques, e.g. based on adhesives application or ink printing techniques. Such coatings can react with substances in gaseous or liquid media to be analysed, changing the transmission properties (wavelength, absorption) of the transparent areas of the window array enabling the detection of the substances. Coatings can be applied, selective, for instance, for the detection of carbon dioxide, ammonia, methanol, ethanol, grades of fuel and other gaseous and liquid substances.

Accordingly, the optical micro-array can form part of an optical micro sensor system as will be further elucidated with reference to FIG. 4. FIGS. 2 and 3 both show—in top view and in cross-sectional view—the same polymer body 1, in which, however, the first areas 2 are transparent and the second areas 3 non-transparent. The areas 2 may serve as transparent (micro-)windows or optical gates, whereas the areas 3 serve as non-transparent barriers, surrounding the window areas 1 and thus preventing optical crosstalk between the individual windows 2. The polymer body 1 is made from the fully transparent semi-manufactured body 1 shown in FIG. 1a or from the fully non-transparent semi-manufactured body 1 shown in FIG. 1b.

When (see FIG. 1a) the body 1 in its semi-manufactured fashion is entirely transparent (including the areas 2 and 3), in order to get its desired final fashion, as shown in FIG. 2, the polymer material in the areas 3, i.e. in the ribs surrounding each individual window area 2, is (re)heated locally to above the polymer's melting temperature and subsequently cooled down sufficiently slow—in the order of hundredths of degrees Celsius per second—to realize that the molten polymer in (only) the areas 3 will crystallize due to the long cooling time, resulting in a non-transparency of the ribs 3 (white in the figure), while the remaining parts of the body, which were not reheated, including the windows 2, will keep the original transparency (black in the figure) of the semi-manufacture.

When (see FIG. 1b) the body 1 in its semi-manufactured fashion is entirely non-transparent (including the areas 2 and 3), in order to get its desired final fashion, as shown in FIG. 3, the polymer in the window areas 2, is (re)heated locally to above the polymer's melting temperature and subsequently cooled sufficiently quick—in the order of tens of degrees Celsius per second—to prevent that the molten polymer in (only) the areas 2 will (re)crystallize, viz. due to the lack of crystallization time, resulting in transparency of the windows 2 (black in the figure), while the remaining parts of the body, which not reheated, including the ribs 3, will keep the original non-transparency (white in the figure) of the semi-manufactured fashion of body 1.

Heating the areas 2 or 3 respectively—e.g. by laser heating—may either be performed when the semi-manufactured body still remains in the mould or in another device after the semi-manufactured body has taken out of the injection mould.

It is noted that in both cases—viz. either starting from a transparent or from a non-transparent semi-manufactured body 1—, the polymer body 1 in semi-manufactured fashion could be made from or even be part of a (pre-manufactured) foil—e.g. stored on a roll—instead of made by injection moulding. When made from foil the areas 3, which are somewhat protruding in the figures, will preferably protrude minimally or entirely not.

In the case that the polymer body 1 in semi-manufactured fashion is made from or part of a pre-manufactured foil, e.g. wound at a storage coil, both process steps could be performed by means of some form of “embossing” or “roll-to-roll” processing. In such a (more continuous) processing environment the heating of the areas 2 or 3 respectively may be performed in the form of a (semi-)continuous process, e.g. during unloading of the semi-manufactured (foil) body—part of a (semi-)continuous foil flow—from its storage coil (reel) either to another storage coil or to another processing or storage module.

FIG. 4 shows schematically an optical micro sensor system 4 comprising the optical micro array 1 according an aspect of the invention. Such a system 4 comprises, for instance, an optical source 5 arranged on one side of the micro-array, for instance, a bottom array of leds, in particular, polymer leds. The leds may be identical or may emit specified, different wavelengths of light. In transmissive mode, on the other side of the micro-array 1 a top array 6 of photodiodes 9 (preferably: polymer photo-diodes) may be provided. Accordingly, light emitted from the bottom array 5 is transmitted to the micro-array 1, provided with an opto-chemically active material 7, which can react with one or more chemical substances of interest in a flow 8. The flow 8 can be provided on localized parts of the array or throughout the array. In addition, multiple substances can be provided subsequently or at the same time to the micro-array 1. The flow 8 may be gaseous or liquid, and changes the transmission properties (wavelength, absorption) of the transparent areas 2 of the micro-array 1 enabling the detection of the substances. Bottom array 5 and top array 6 may be connected to a processing unit 10, comprising analog/digital conversion circuitry and a processor for driving the optical source 5 and/or the array of photo-diodes 9.

In the context of this application, an area 2 is considered to be transparent if it is suitable for guiding light, in particular it is considered transparent if the transmittance of light of at least a particular wavelength through 1 mm of the area is at least 80%, preferably at least 90%, and more preferably 95-100%.

An area 3 is considered to be non-transparent if it is suitable to serve as a light barrier, in particular if the transmittance of light of at least a particular wavelength through 1 mm of the area is at most 20%, preferably at most 10%, and more preferably 0-5%. Such non-transparent areas are suitable for acting as a light barrier.

In principle, the light wavelength can be any wavelength in the ultraviolet, visible or infrared spectrum, in particular any wavelength from 190 to 1 500 nm. Preferably, the area is transparent respectively non-transparent over a wavelength range of at least 50 nm, preferably at least 100 nm. Usually, the wavelength range will not exceed 250 nm. Preferably, the transparent areas are transparent for light with a wavelength between 400 and 800 nm and the non-transparent areas are not transparent for light within this range.

The optical micro-array can be composed of any semi-crystalline thermoplastic polymer, including copolymers and blends. In particular, such polymers include polyethyleneterephthalates, polyamides, polymethylpentenes, polypropylenes, and polyethylenenaphthalates.

Although the invention has been explained with reference to exemplary embodiments, it is not limited thereto. For instance, alternatively, the optical micro-array can be provided in a reflective mode, for instance, by integrating a reflective surface in the array 1 or placing the array on a reflective surface provided in the sensor system (not shown). The scope of the invention is defined by the claims annexed hereto.

1-6. (canceled)

7. A method for manufacturing a polymer body which comprises one or more first areas which are transparent and one or more second areas which are non-transparent, the method comprising the steps:
a. producing a semi-manufactured body comprising said first areas and said second areas, which are either both transparent or both non-transparent;
b. when the first and the second areas of the semi-manufactured body are transparent, heating the polymer in said second areas to above the polymer's melting temperature and subsequently cooling slowly so as to realize substantial crystallization of the polymer in the second areas; and
c. when the first and the second areas of the semi-manufactured body are non-transparent, heating the polymer in said first areas to above the polymer's melting temperature and subsequently cooling quickly so as to prevent substantial crystallization of the polymer in the first areas.

8. (canceled)

9. The method according to claim 7, wherein said semi-manufactured body is made using a mould, and heating the first or second areas is performed when the semi-manufactured body still remains in the mould.

10. The method according to claim 7, wherein said semi-manufactured body is made using a mould, and heating the first or second areas is performed after the semi-manufactured body has been taken out of the mould.

11. The method according to claim 7, wherein heating the first or second areas is performed by means of one or more laser beams.

12. The method according to claim 7, further comprising: applying, to make said first areas transparent, a cooling rate on the order of tens of degrees Celsius per second.

13. The method according to claim 7, further comprising: applying, to make said second areas non-transparent, a cooling rate on the order of hundredths of degrees Celsius per second.

14. The method according to claim 7, wherein said semi-manufactured body is stored at storage means, and heating the first or second areas is performed when the semi-manufactured body still remains in the mould at said storage means.

15. The method according to claim 7, wherein said semi-manufactured body is stored at first storage means, and heating the first or second areas is performed when moving the semi-manufactured body from said first storage means to second storage means.
